(19) United States
(12) Patent Application Publication
(10) Pub. No.: US 2018/0131107 A1
(43) Pub. Date: May 10, 2018

(54) PATCHBOARD

(71) Applicant: Phoenix Contact GmbH & Co. KG, Blomberg (DE)

(72) Inventors: Marcel Willems, Blomberg (DE); Jürgen Brand, Detmold (DE); Ralph Hoppmann, Bad Oeynhausen (DE); Christian Kloppenburg, Büren Wewelsburg (DE); Kevin Berghahn, Blomberg (DE)

(73) Assignee: Phoenix Contact GmbH & Co. KG, Blomberg (DE)

(21) Appl. No.: 15/565,527

(22) PCT Filed: Apr. 8, 2016
(86) PCT No.: PCT/EP2016/057709

§ 371 Date: Oct. 10, 2017

(30) Foreign Application Priority Data
Apr. 10, 2015 (DE) 10 2015 105 548.1

(51) Int. Cl. H01R 9/24; H01R 9/26

(52) U.S. Cl. CPC H01R 9/2408; H01R 9/2675; H01R 9/2608

(57) ABSTRACT

The invention illustrates and describes a patchboard comprising a plurality of socket blocks (2), wherein the individual socket blocks (2) each have a box-like housing (3) with two end faces (4a, 4b) and four side faces (5a, 5b, 5c, 5d) which extend between the end faces (4a, 4b), and wherein the two end faces (4a, 4b) of the socket blocks (2) each have at least one connection region (6). The patchboard (1) according to the invention has an increased degree of flexibility and ability to adapt to individual requests of a user as a result of at least two side faces (5a, 5b, 5c, 5d) of the socket blocks (2) each having at least one latching element for connection to another socket block (2), and by at least one termination element (11) being arranged on at least one side of the patchboard (1), wherein the termination element (11) has a mating latching element on at least one side face (12, 12b), the termination element (11) being connected to an adjacent socket block (2) by means of said mating latching element.

### BACKGROUND OF THE INVENTION

### Field of the Invention

The invention relates to a patchboard with multiple honeycomb components, whereby the individual honeycomb components in each case have a box-shaped housing with two front surfaces and four side surfaces, which extend between the front surfaces, and whereby the two front surfaces of the honeycomb components in each case have at least one connecting area.

### Description of Related Art

Patchboards are used in particular in places where a number of electrical conductors must be connected in a very tight space. To this end, patchboards are known from experience in which within a solid, rectangular assembly frame, a number of honeycomb components are arranged in corresponding chambers of the frame. Electrical conductors can be connected to the patchboard or the individual honeycomb components both from the front, or field side, and from the rear, or plant side. To this end, connecting elements are arranged in the box-shaped housings of the individual honeycomb components, which elements are in general connected to one another via corresponding busbars, so that an electrical conductor that is inserted through a corresponding conductor inflow opening in the forward front surface can be electrically connected to an electrical conductor or to a connecting contact that is inserted through a corresponding inflow opening in the rear front surface of the housing.

Such a patchboard having a number of honeycomb components is known from, for example, DE 195 12 226 A1. In the patchboard that is disclosed in this publication, the individual honeycomb components, which are inserted into the individual chambers of the assembly frame, all have the same dimensions and the same number and size of conductor inflow openings. On its upper and lower edge sides, in each case a fastening flange base is tightly connected to the patchboard, via which the patchboard can be screwed onto an assembly frame. In addition, clamping modules can be mechanically fastened via dovetail-shaped connections to the fastening flange bases, whereby an electrical connection to the metal assembly frame can be made via a contact plate that is inserted into the bottom of the clamping module. Adapting the patchboard to a user's individual needs is not possible in the case of this known patchboard. If the number of conductors that are to be connected has to be increased, a correspondingly larger patchboard having a larger number of individual honeycomb components thus has to be used, whereby in practice, patchboards with 18, 32, 48, 54 or 80 honeycomb components are available. For fastening, a different assembly frame that is adapted to the dimensions of the patchboard must then be used.

A patchboard, as it is used in, for example, rolling stock for electrical distribution, is known from DE 10 2013 101 830 A1. Depicted in FIGS. 7 and 8 of this publication are two different assembly frames or distributor housings, in which in each case, a preset number—18 or 54—of chambers is laid out in matrix form, in which in each case a honeycomb component with two conductor inflow openings in the forward front surface is arranged. Also, in the case of this patchboard, a fastening flange base is also tightly connected to the patchboard on the upper and lower edge sides of the patchboard, so that the patchboard can be fastened by means of two screws, for example, to a switch cabinet wall. In the case of this patchboard, the production of the individual honeycomb components is to be simplified in such a way that the housing has a main housing part and a housing closure part, so that a contact insert having the connecting elements can be easily inserted through an assembly opening in the main housing. Flexible adaptation of the patchboard to a user's individual needs is, however, also not possible here.

### SUMMARY OF THE INVENTION

The object of this invention is therefore to make available a patchboard with multiple honeycomb components, which are distinguished by an increased flexibility and better adaptability to a user's individual needs.

This object is achieved in the case of the above-described patchboard with the features that at least two side surfaces of the honeycomb components in each case have at least one latching element for connecting to another honeycomb component, and in that at least one terminal element is arranged on at least one side of the patchboard. On at least one side surface, the terminal element has at least one mating latching element, by means of which the terminal element is connected to an adjacent honeycomb component.

The patchboard according to this invention first has a greater flexibility, so that the individual honeycomb components can be directly connected to one another, so that they have in each case at least one latching element on at least two side surfaces, and so that the use of a rigid assembly frame that sets the number of individual honeycomb components can be eliminated. As a result, the patchboard can have any number of honeycomb components, so that the size and the number of poles of the patchboard can be adapted to the respective requirement and, if necessary, can also be easily changed. In the case of the patchboard according to the invention, the flexibility and the number of different possible applications are further increased in such a way that at least one terminal element is arranged on at least one side of the patchboard, whereby the terminal element can be fastened in a flexible manner to an edge-side honeycomb component of the patchboard by making a mating latching element. The latching connection between the at least one latching element and the at least one mating latching element, made between the terminal element and the honeycomb components, makes it possible in this case to detachably connect the terminal element to the desired position on the patchboard. In this regard, adapting the patchboard to changed requirements is easily possible.

Preferably, on all four side surfaces of the honeycomb components, at least one latching element for connecting to another honeycomb component is provided. In this case, the latching elements, which are designed on side surfaces that are opposite to one another, are designed corresponding to one another, so that a honeycomb component can be connected to another honeycomb component both in the x-direction and in the z-direction. The latching elements that correspond to one another in this case can be designed as, for example, latching pins and latching openings, as arms and grooves, in particular as dovetail-shaped arms and corresponding dovetail-shaped grooves or as latching catches and latching projections.

The terminal elements have mating latching elements on the side surface facing the honeycomb components, which elements correspond to the latching elements of the honeycomb components that are provided on the opposite side surface. If the honeycomb components on the corresponding side surface have, for example, arms, corresponding grooves are made in the opposite side surface of the terminal elements. According to another possible embodiment, in each case at least one arm is made as a latching element on a side surface of the honeycomb component, and at least one groove that corresponds to the arm is made as a mating latching element on the opposite side surface of a terminal element. Preferably, in this case, the arms and the grooves in each case have dovetail-shaped cross-sections that correspond to one another.

In the case of the patchboard according to the invention, the cross-sectional dimensions of a terminal element can correspond to the cross-sectional dimensions of a honeycomb component; in particular, a terminal element can have the same width as a honeycomb component. In addition, however, the possibility also exists that the patchboard has a terminal element that has a greater width than a honeycomb component. Thus, in this case also, the terminal element can be easily connected to edge-side honeycomb components if the terminal element has a width W_{A} that is a whole multiple of the width W_{W} of a honeycomb component. The latching of such a terminal element with multiple honeycomb components is in this case ensured in such a way that the number of mating latching elements of the terminal element is a corresponding multiple of the number of latching elements of a honeycomb component. In the case of a double-wide terminal element in comparison to the width of a honeycomb component, the terminal element on its side surface facing the honeycomb component thus has a double number of mating latching elements in comparison to the number of corresponding latching elements of an individual honeycomb component. A double-wide terminal element can thus be easily fastened to two single-wide honeycomb components.

Because of the configuration of the patchboard according to the invention, there exists not only the possibility of arranging a terminal element, if necessary, in different positions of the patchboard, but also the possibility of connecting different terminal elements to the edge-side honeycomb components, if necessary. By selecting suitable terminal elements, the patchboard can thus be adapted to different requirements in a simple way, so that a customer's varying needs can be met.

The terminal elements can be designed, for example, in such a way that they are used to fasten the patchboard to a wall, for example a switch cabinet wall. To this end, a terminal element preferably has at least one fastening area with at least one opening, through which a fastening element, for example a screw, can be passed.

As an alternative or in addition, the terminal element can also have a marking area for identifying the patchboard or an area of the patchboard. The marking area in this case can be either directly inscribed or the marking area has at least one guide groove, in which a corresponding identifying sign can be engaged. Preferably, the marking area has two guide grooves on two sides that are arranged perpendicular to one another, so that the inscription or identification of the patchboard from two different directions of view is easily ensured.

According to an additional configuration of the invention, a terminal element that is used for fastening can also be designed as a snap-on foot for latching the patchboard to a support rail, whereby the terminal element then has two latching legs that are opposite one another and that accommodate the support rail in a clamping manner in between. Using such a terminal element that is fastened to the patchboard, the patchboard can then be fastened in a detachable manner to a support rail. Depending on the size of the patchboard, in this case even more than one snap-on foot, in particular two snap-on feet, can be used.

A terminal element can also be designed as an equalization element according to another advantageous configuration of the invention, so that the outside dimensions of the patchboard can be adapted to a specific installation dimension that is provided by a customer. Such a terminal element that is designed as an equalization element can in this case be used in particular for adapting the overall height of the patchboard to a preset installation height, and therefore the equalization element can be fastened to the upper side and/or to the lower side of the patchboard.

Such a terminal element that is designed as an equalization element in this case preferably has at least one arm on its side surface and at least one groove on the opposite side surface, so that the terminal element can be fastened both to the top of the patchboard and to the bottom of the patchboard on the edge-side honeycomb components. Moreover, such a configuration of the terminal element having at least one arm on a side surface and at least one groove on the opposite side surface offers the possibility that another terminal element, for example a terminal element that is provided for fastening, can be attached on the side surface of the terminal element that faces away from the edge-side honeycomb component. Furthermore, such an equalization element can then also be arranged within the patchboard, for example between two rows of honeycomb components. Also, as a result, adapting the overall height of the patchboard to a preset installation dimension by selecting a correspondingly dimensioned terminal element is easily possible, without the individual honeycomb components having to be changed.

According to another configuration of the invention, in each case a terminal element is arranged on two opposite sides of the patchboard, whereby the two terminal elements are designed in such a way that they make possible a pivotable fastening of the patchboard. To this end, the two terminal elements preferably in each case have a connecting area, a holding area, and a fastening area with at least one opening. The at least one mating latching element of the terminal element is in this case made on the connecting area, so that the latter is connected in the mounted state having at least one, preferably a number of, edge-side honeycomb component(s). The connecting area is connected via a swivel axis to the holding area, which is arranged in a perpendicular manner to the fastening area. The holding area and the fastening area thus form a fastening angle that can be attached by means of screws, which are inserted through the openings in the fastening area, to a wall, for example to a switch cabinet wall.

In the case of another configuration, the terminal element has a connecting area and a conductor guide area, whereby even in the case of this variant of the terminal element, the at least one mating latching element is made on the connecting area. The conductor guide area that is made preferably in an integral manner with the connecting area projects when mounted over the forward front surface of the honeycomb components, so that the conductors that are to be connected to the honeycomb components can be fastened to the conductor guide area. The fastening of the conductors that are to be connected to the conductor guide area can be done, for example, using cable ties, by which traction relief of the conductors that are to be connected is also ensured. As an alternative, the conductor guide area can also have multiple clamping sections for clamping individual conductors, so that also in this regard, both a guide and traction relief of the connected conductors are provided.

More specifically, there are now a considerable number of possibilities to configure and to further develop the patchboard according to the invention and the individual honeycomb components. To this end, reference is made both to the claims following claim 1 and the subsequent description of preferred embodiments in connection with the drawings. In the drawings,

### BRIEF DESCRIPTION OF THE DRAWINGS

FIG. 1 shows an embodiment of a patchboard that is built up from a number of honeycomb components,

FIG. 2 shows the patchboard according to FIG. 1 having multiple terminal elements, in the still unmounted state and in the mounted state,

FIG. 3 shows the patchboard, according to FIG. 1 with additional terminal elements, in the still unmounted state and in the mounted state,

FIG. 4 shows a patchboard that is similar to the patchboard according to FIG. 1, with two terminal elements that are designed as equalization elements,

FIG. 5 shows two embodiments of a terminal element that is used for fastening,

FIG. 6 shows an embodiment of a terminal element that is used for identification,

FIG. 7 shows an embodiment of a terminal element that is designed as an equalization element,

FIG. 8 shows two embodiments of a terminal element that is used for fastening and for identification,

FIG. 9 shows another embodiment of a terminal element that is used for fastening and for identification,

FIG. 10 shows an embodiment of a terminal element that is designed as a catch foot,

FIG. 11 shows an embodiment of a patchboard that is fastened in a pivotable manner, and

FIG. 12 shows a patchboard with a terminal element that is used for guiding conductors.

### DETAILED DESCRIPTION OF THE INVENTION

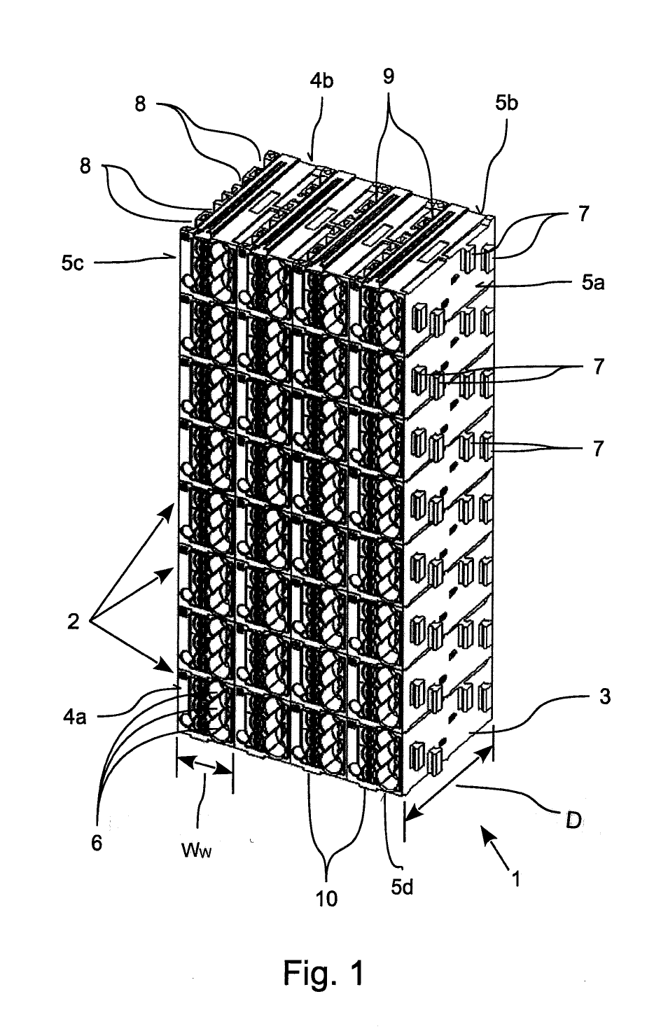

FIG. 1 shows an embodiment of a patchboard 1, which has a number of honeycomb components 2, whereby the individual honeycomb components 2 are connected to one another directly. The patchboard 1, which consists of 32 honeycomb components 2 overall, thus does not have any solid assembly frames, into whose individual chambers the individual honeycomb components 2 are inserted, so that the number of individual honeycomb components 2 and thus also the dimensions of the patchboard 1 can be flexibly adapted to the respective requirements of a user.

The individual honeycomb components 2 in each case have a box-shaped housing 3 with two front surfaces 4a, 4b and four side surfaces 5a, 5b, 5c, and 5d. In this case, the individual side surfaces 5a, 5b, 5c, 5d extend between the two front surfaces 4a, 4b and in each case have an angle of 90° to the front surfaces 4a, 4b. The honeycomb component 2 thus has a rectangular cross-section, having a width W and a height H. Furthermore, the honeycomb components 2 have a length or depth D. In the depicted patchboard 1, all honeycomb components 2 have the same dimensions, without the invention, however, being limited thereto. In the depicted honeycomb components 2, the dimensions W×H×D are, for example, 12 mm×11 mm×30 mm, whereby these dimensions are also by no means limiting.

On the forward front surface 4a of the honeycomb components 2, in each case three connecting areas 6, which are preferably designed as spring-force clamping connections, are provided. Within the housing 3, three clamping springs are arranged, whereby by means of the clamping springs, a conductor, stripped of insulation, that is inserted through a respective conductor inflow opening of a connecting area 6, can be clamped against a busbar, also arranged in the housing 3, and thus can be connected in an electrically conductive manner to the busbar. The rear front surface 4b can also have three connecting areas. In addition, it is also possible, however, that the two front surfaces 4a, 4b have a different number of connecting areas; the rear front surface 4b, for example, has only two connecting areas.

To connect the honeycomb components below one another, the honeycomb components 2 on all four side surfaces 5a, 5b, 5c, 5d have at least one latching element. As a result, a honeycomb component 2 can be connected on all four of its side surfaces 5a, 5b, 5c, 5d, and thus both in the x-direction and in the z-direction, to another honeycomb component 2, in order to form a patchboard 1, as it is depicted in, for example, FIG. 1.

The honeycomb components 2 in each case have four dovetail-shaped arms 7 on the first side surface 5a, to which arms grooves 8 that correspond to the side surface 5c of a honeycomb component 2 that is opposite to the side surface 5a are made, which grooves also have a dovetail-shaped cross-section. As a result, two honeycomb components 2 can be connected to one another in the x-direction by the arms 7, arranged on the side surface 5a of the one honeycomb component 2, being inserted into the grooves 8 made on the side surface 5c of the adjacent honeycomb component 2.

In each case, a groove 9, which extends approximately over the entire depth D of a honeycomb component 2, is made on the upper side surface 5b of the housing 3. Corresponding to the groove 9, an arm 10 is made in each case on the lower side surface 5d of the honeycomb components 2, so that two honeycomb components 2 can also be arranged in the z-direction one above the other by the arm 10 on the lower side surface 5d of an upper honeycomb component 2 being inserted into the groove 9 on the upper side surface 5b of a lower honeycomb component 2.

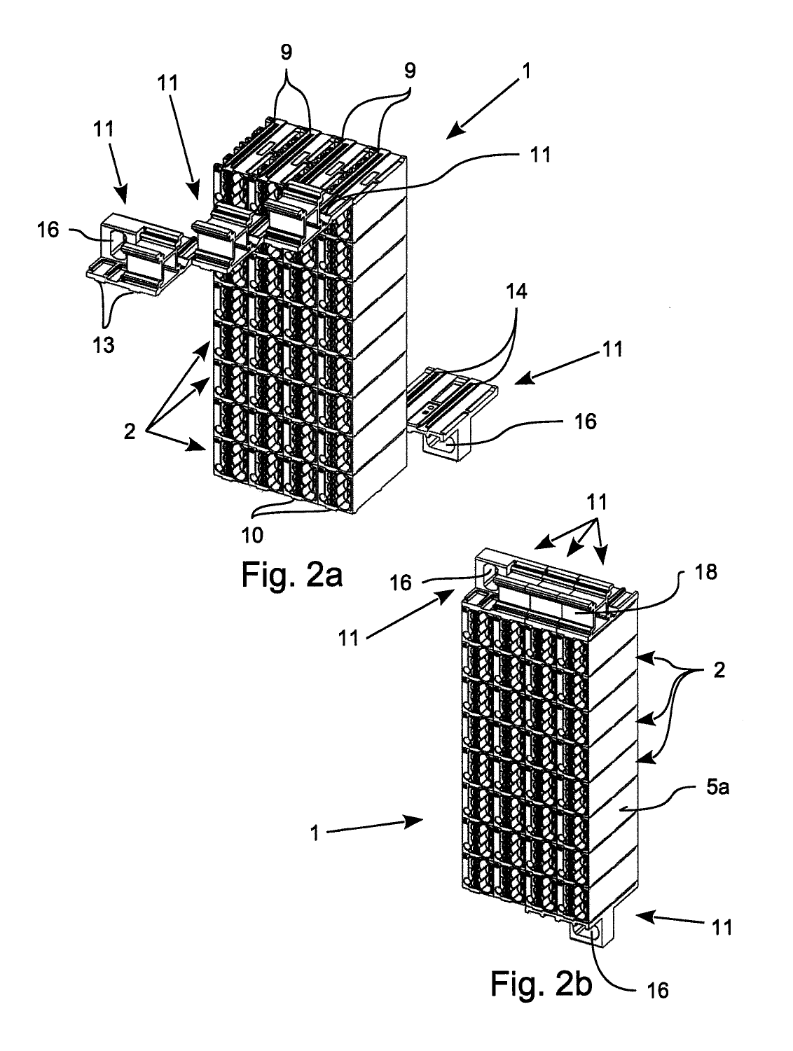

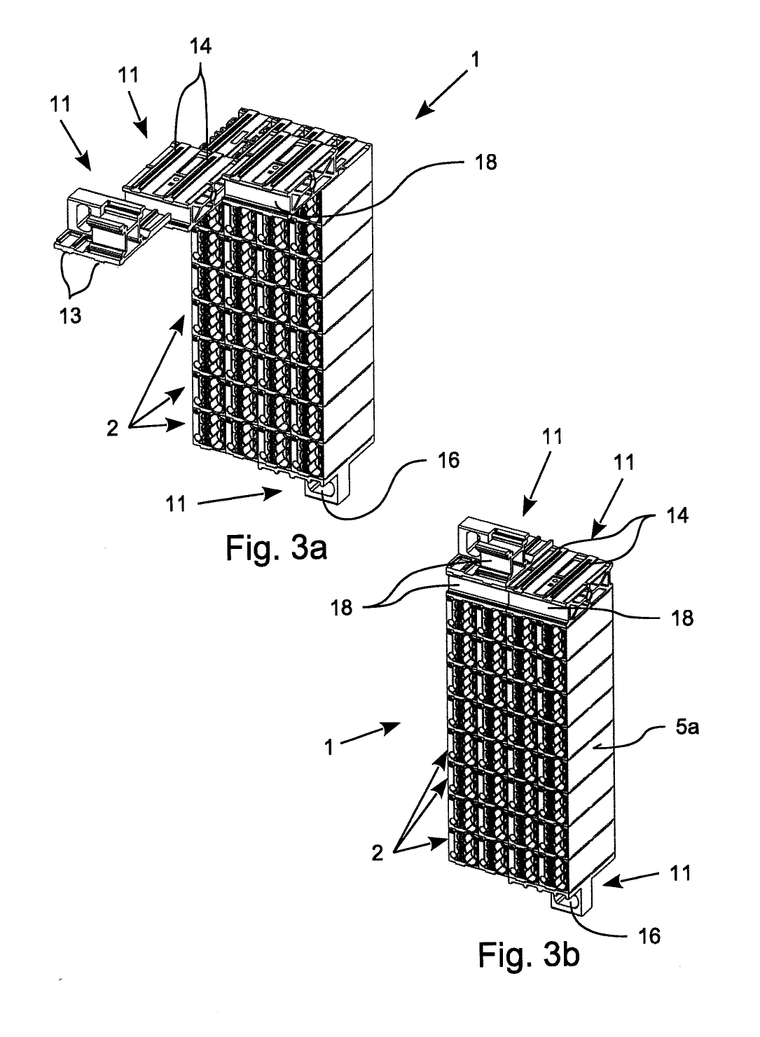

FIGS. 2 and 3 show the patchboard 1 according to FIG. 1 together with multiple terminal elements 11, in each case once with not yet completely mounted terminal elements 11 and once with mounted terminal elements 11. In the depicted embodiments, terminal elements 11 are provided both on the upper side and on the lower side of the patchboard 1, whereby the fastening of the terminal elements 11 to the adjoining, edge-side honeycomb components 2 is carried out in such a way that the terminal elements 11 have mating latching elements at least on the side surface 12a that is opposite to the adjoining honeycomb components 2, which mating latching elements correspond to the latching elements of the honeycomb components 2. As a result, the terminal elements 11 can be easily fastened to the edge-side honeycomb components 2 and also detached again from the honeycomb components 2, if necessary.

As FIGS. 2 and 3 show, the patchboard 1 can be connected, if necessary, to different terminal elements 11, so that a patchboard 1 that corresponds to the respective requirements can be made available. In contrast to the patchboard 1 that is depicted in FIG. 1, the honeycomb components 2 that form the right side edge of the patchboard 1 do not have any latching elements on their side surface 5a, so that no additional honeycomb components 2 can be fastened to this side. In principle, however, even in the case of the patchboards 1 that are depicted in FIGS. 2 and 3, the honeycomb components 2 that form the right side edge of the patchboard 1 can also have latching elements on their side surfaces 2, as is depicted in the case of the patchboard 1 according to FIG. 1.

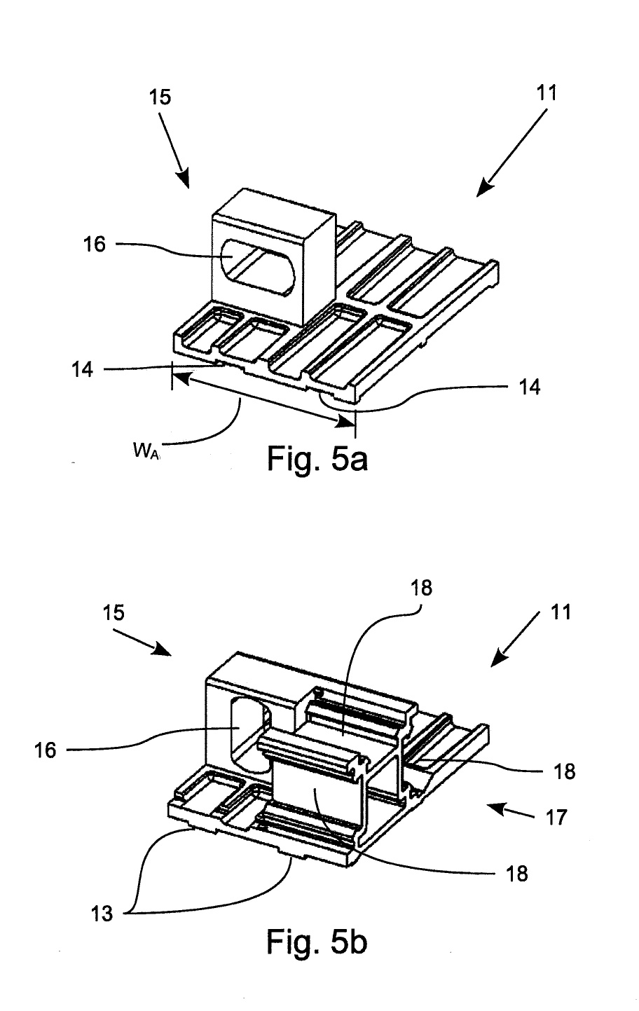

In the case of the embodiment of the patchboard 1 that is depicted in FIGS. 2a and 2b, the three terminal elements 11, which are connected to the upper honeycomb components 2, in each case have at least one arm 13 on their side surface 12a that faces the honeycomb components 2, which arm can be inserted into the groove 9 that is made on the side surface 5b of the honeycomb component 2. The terminal element 11, which is connected to the lower, edge-side honeycomb components 2, however, has two grooves 14 on its side surface 12a that faces the honeycomb components 2, which grooves can be connected to the corresponding arms 10 on the side surface 5d of two adjacent honeycomb components 2. This terminal element 11, which is used to fasten the patchboard 1, for example, to a switch cabinet wall, is also depicted separately in FIG. 5a. This shows that the terminal element 11 has a fastening area 15 with an opening 16 through which a screw, not depicted here, passes and can be screwed into a corresponding hole in a switch cabinet wall.

The upper left terminal element 11 that is depicted in FIG. 2 is also depicted separately in FIG. 5b. This terminal element 11 is also used in the fastening of the patchboard 1, so that it also has a fastening area 15 having an opening 16. In order to facilitate the fastening of the patchboard 1 to, for example, a switch cabinet wall, in which holes are already provided for the screws to pass through the opening, the openings 16 made in the fastening areas 15 are made in each case as longitudinal openings, whereby the longitudinal axes of the two openings 16 are oriented perpendicular to one another.

In the case of the terminal element 11 that is depicted in FIG. 5b, a marking area 17 is also provided in addition to the fastening area 15, which marking area has two guide grooves 18, which are made on two side surfaces that are arranged perpendicular to one another. In the two guide grooves 18, in each case a marking sign can be engaged for marking the patchboard 1 or an area of the patchboard 1. In the case of the terminal element 11 that is depicted in FIG. 5b, the marking area 17 in addition has a third guide groove 18, in which a corresponding identifying sign can also be engaged. This guide groove 18 is arranged in such a way that an engaged identifying sign can be read from the rear of the patchboard 1, the plant side.

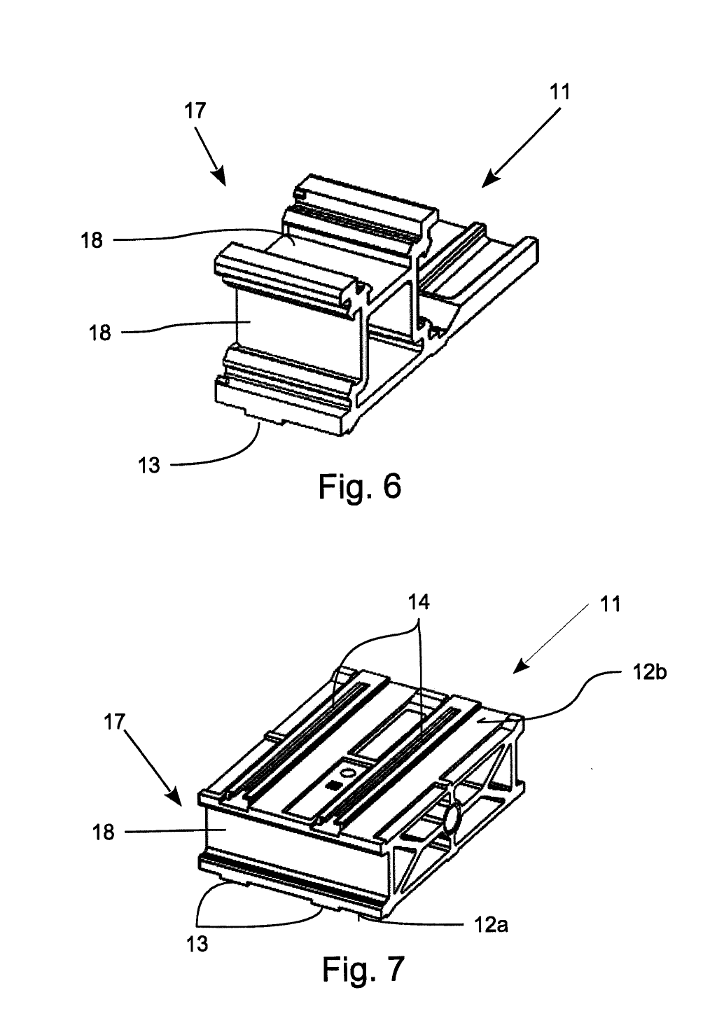

In the case of the patchboard 1 that is depicted in FIG. 2, two more terminal elements 11, which are used exclusively to the marking, are also provided on the top. Such a terminal element 11 is depicted separately in FIG. 6. The terminal element 11 has a marking area 17, on which a total of three guide grooves 18 are made. It can be seen from FIG. 2 as well as from a comparison of the two terminal elements 11 that are depicted in FIGS. 5a and 5b having the terminal element 11 that is depicted in FIG. 6 that the terminal elements 11 that are depicted in FIG. 5 have a width W_{A} that is twice as large as the width W_{W} of a honeycomb component 2. So that these terminal elements 11 can be connected to the honeycomb components 2, they have a double number of mating latching elements, namely two grooves 14 (FIG. 5a) or two arms 13 (FIG. 5b), in comparison to the number of latching elements, namely a groove 9 or an arm 10 of the honeycomb components 2.

The patchboard 1 that is depicted in FIG. 3 is distinguished from the patchboard 1 that is depicted in FIG. 2 in such a way that the terminal element 11 that is used for fastening and marking and that is depicted separately in FIG. 5b is not connected directly to the upper, edge-side honeycomb components 2. In the case of this embodiment, two terminal elements 11 that are used as equalization elements and that are depicted separately in FIG. 7 are also provided. In the case of the terminal element 11 according to FIG. 7 that is used here as a height equalization element, two arms 13 are made on the side surface 12a that faces the honeycomb components 2 and two grooves 14 are made on the opposite side surface 12b. As a result, this terminal element 11 can be connected via the arms 13 to two upper, edge-side honeycomb components 2 and via the grooves 14 to one or two additional terminal elements 11, for example to the terminal elements 11 that are depicted in FIG. 5. FIG. 3 shows that also here, as in the embodiment according to FIG. 2, two terminal elements 11 according to FIG. 6 that are used for marking could also be fastened to the second right terminal element 11 that is used as a height equalization element.

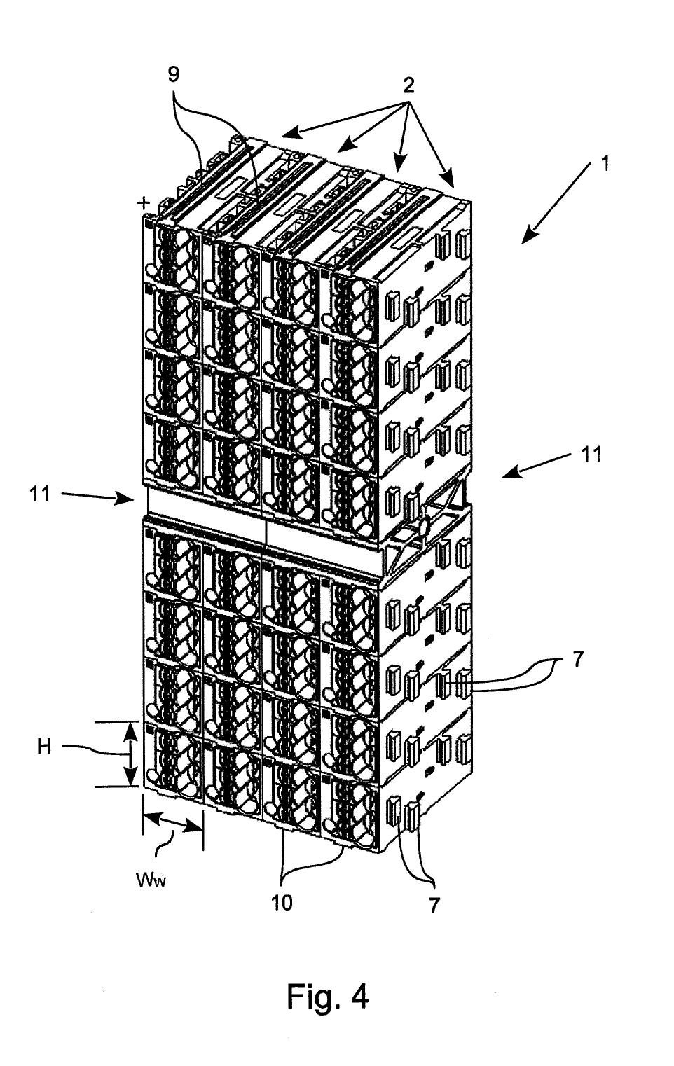

A patchboard 1 is depicted in FIG. 4, which—just like the patchboard 1 that is depicted in FIGS. 1 to 3—has a total of 32 honeycomb components 2. Moreover, the patchboard 1 that is depicted in FIG. 4 also has two terminal elements 11 that are used as height equalization elements, which, however, unlike the embodiment according to FIG. 3, are not arranged on the upper side of the patchboard 1 but rather in the center of the patchboard 1, i.e., between two rows of honeycomb components 2. The two terminal elements 11 that are used in the case of the patchboard 1 according to FIG. 4 correspond in this case to the terminal element 11 that is depicted separately in FIG. 7.

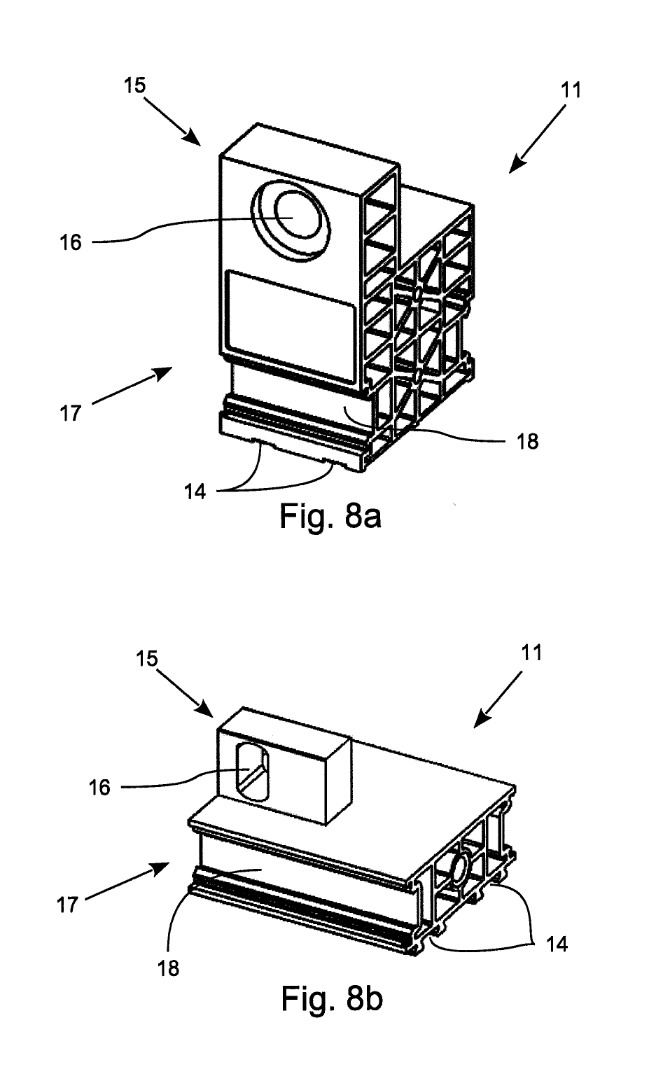

In FIG. 8, two additional embodiments of a terminal element 11 are depicted, which in each case are used for fastening and marking a patchboard 1. The two terminal elements 11 in each case have a fastening area 15 having an opening 16 and a marking area 17 having a guide groove 18 for an identifying sign. As can be seen in particular from a comparison of the two terminal elements 11 that are depicted in FIGS. 8a and 8b having the terminal element 11 that is depicted in FIG. 5b, the terminal elements 11 that are depicted in FIG. 8 are also used as height equalization. This is achieved in particular in that the fastening area 15 and the marking area 17 are not—as in the execution part according to FIG. 5b—arranged beside one another but rather above one another. By a corresponding sizing of a terminal element 11 that is used as an equalization element, it is thus possible in a simple way to adapt a patchboard 1, which has a specific number of honeycomb components 2, to a specific installation dimension.

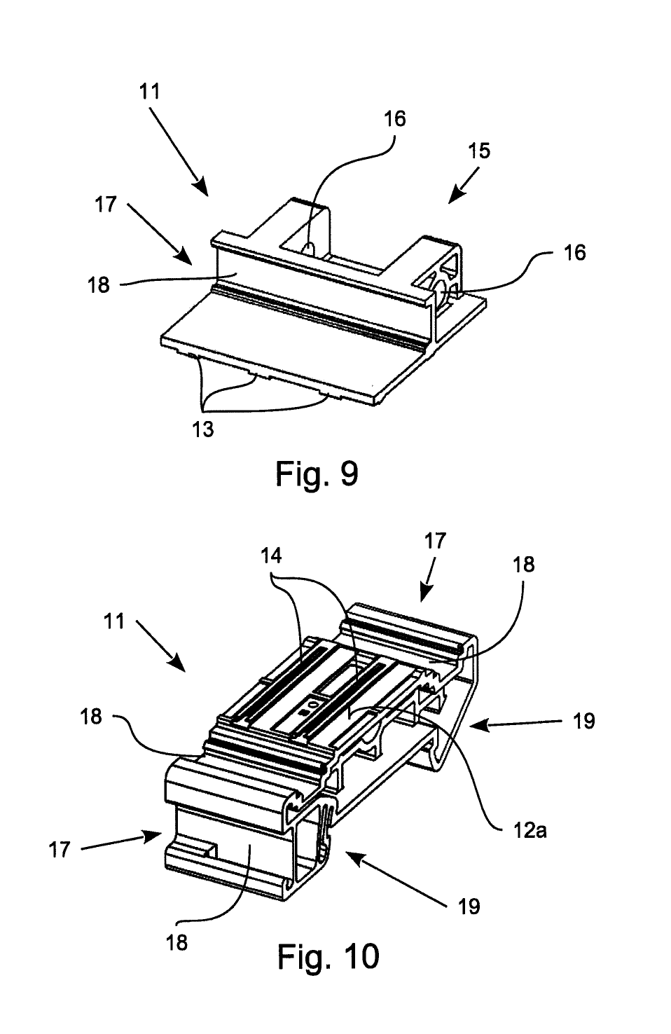

FIGS. 9 and 10 show two additional embodiments of a terminal element 11, which is used for fastening and marking a patchboard 1. The terminal element 11 that is depicted in FIG. 9 has a fastening area 15 with two openings 16, through which a rod can be pushed, so that the fastening element 11 and, with the latter, also a patchboard 1 can be fastened to a corresponding rod. Since the terminal element 11 that is depicted in FIG. 9 has a width that is three times as large as the width of a single honeycomb component 2, the terminal element 11 has three arms 13 on its side surface 12a that faces the honeycomb components 2, which arms can be pushed into the grooves 9 on the upper side surface 5b of three honeycomb components 2 that are arranged beside one another.

The terminal element 11 that is depicted in FIG. 10 is designed as a snap-on foot for latching onto a support rail, and therefore the terminal element 11 has two latching legs 19, between which the support rail can be clamped. On its side surface 12a that faces the honeycomb components 2, this terminal element 11 has two grooves 14, into which the arms 10 that are made on the lower side surface 5d of two adjacent honeycomb components 2 can be pushed.

The two terminal elements 11 that are depicted in FIGS. 9 and 10 are also used, moreover, for identifying a patchboard 1, and therefore the terminal element 11 according to FIG. 9 has a marking area 17 with a guide groove 18. The terminal element 11 according to FIG. 10 that is designed as a snap-on foot has two marking areas 17, whereby two guide grooves 18 are made on the front marking area 17 and a guide groove 18 is made on the rear marking area 17.

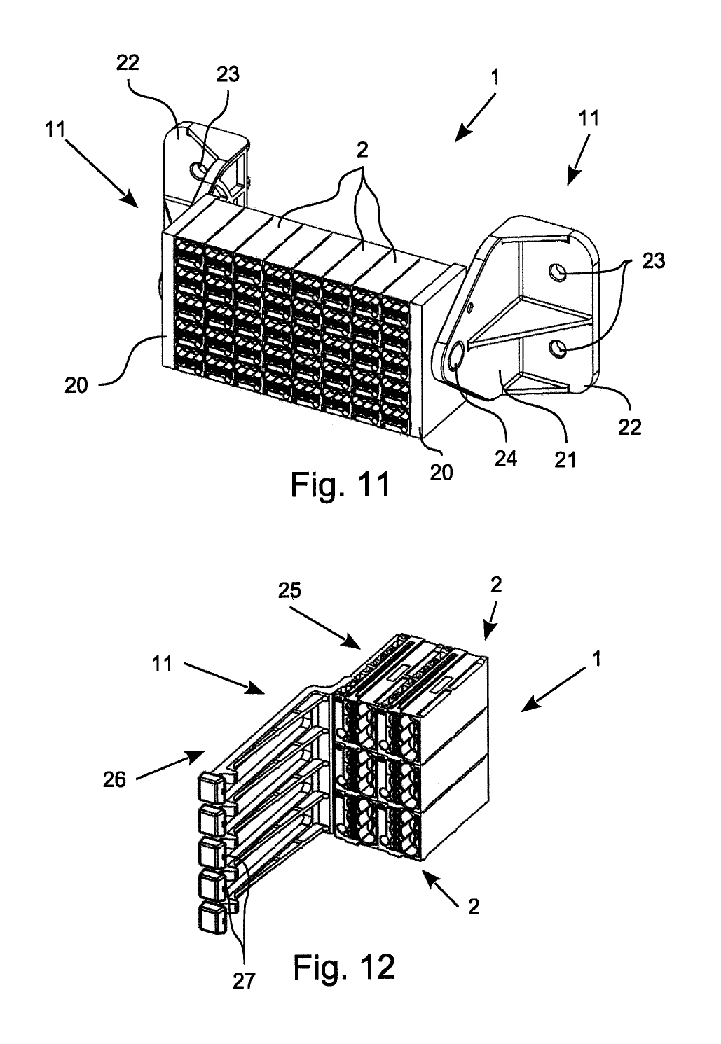

FIG. 11 shows another embodiment of a patchboard 1, in which in each case, a terminal element 11 is arranged on two sides that are opposite to one another. Using the two terminal elements 11, the patchboard 1 can be fastened to, for example, a switch cabinet wall, whereby the two terminal elements 11 are designed in such a way that the patchboard 1 can be swiveled when mounted. To this end, the two terminal elements 11 in each case have a connecting area 20, on which the mating latching elements are made. The connecting areas 20 are thus connected in a detachable manner to the edge-side honeycomb components 2 of the patchboard 1 via the mating latching elements and the latching elements that are made on the honeycomb components 2. Moreover, the two terminal elements 11 in each case also have a holding area 21 and a fastening area 22, which are arranged perpendicular to one another, so that they form a fastening angle together. In the fastening area 22, two openings 23 are made, which openings are used to accommodate screws with which the terminal elements 11 can be fastened to a wall. The previously-cited swivelable arrangement of the patchboard 1 is ensured in that the two connecting areas 20 in each case are connected via a swivel axis 24 to the respective holding area 21 of the terminal element 11.

Finally, FIG. 12 shows an embodiment of a patchboard 1, which has only six honeycomb components 2. In addition, this patchboard 1 also has a terminal element 11, which is used to guide and hold the conductor that is to be connected to the honeycomb component 2. To this end, the terminal element 11 has a connecting area 25 and a conductor guide area 26. In this case, multiple arms are made on the connecting area 25, which arms engage with the grooves 8 made on the side surface 5c of the adjoining honeycomb components 2. The conductor guide area 26 that is made in an integral manner with the connecting area 25 projects over the forward front surface 4a of the honeycomb components 2, so that the conductors that are to be connected can be fastened to the conductor guide area 26. To this end, multiple clamping sections 27 for clamping the individual conductors are made on the conductor guide area 26, by which traction relief of the connected conductors can also be achieved.

What is claimed is:

1.-10. (canceled)

11. A patchboard comprised of multiple honeycomb components, wherein individual ones of the honeycomb components each have a box-shaped housing with two front surfaces and four side surfaces, which extend between the front surfaces, and wherein the two front surfaces of the honeycomb components in each case have at least one connecting area,
wherein:
at least two side surfaces of the honeycomb components each have at least one latching element for connecting to another honeycomb component,
at least one terminal element is arranged on at least one side of the patchboard, and
the at least one terminal element has a mating latching element on at least one side surface, by means of which mating latching element the terminal element is connected to an adjacent honeycomb component.

12. The patchboard according to claim 11, wherein in each honeycomb component, a groove is formed as a latching element on a side surface of the honeycomb component, and at least one arm that corresponds to the groove is formed as a mating latching element on an opposite side surface of the terminal element.

13. The patchboard according to claim 11, wherein in each case, at least one arm is formed as a latching element on a side surface of at least one of the honeycomb components, and at least one groove that corresponds to the arm is formed as a mating latching element on an opposite side surface of the terminal element.

14. The patchboard according to claim 11, wherein the terminal element has a width W_{A}, which corresponds to a whole multiple of the width W_{W} of at least one of the honeycomb components, and wherein the number of mating latching elements of the terminal element is a corresponding whole multiple of the number of latching elements of the at least one of the honeycomb components.

15. The patchboard according to claim 11, wherein the terminal element has at least one fastening area having at least one opening.

16. The patchboard according to claim 11, wherein the terminal element has a marking area with at least one guide groove.

17. The patchboard according to claim 16, wherein the marking area has two guide grooves on two sides of the marking area that are arranged perpendicular to one another.

18. The patchboard according to claim 11, wherein a terminal element is structured as an equalization element, and at least one arm is formed on a side surface of the terminal element, and at least one groove is formed on an opposite side surface of the terminal element.

19. The patchboard according to claim 11, wherein the terminal element is structure as a snap-on foot for latching on a support rail and has two opposite latching legs.

20. The patchboard according to claim 11, wherein at least two terminal elements are provided, and, in each case, the at least two terminal elements are arranged on two opposite sides of the patchboard, wherein the two terminal elements each have a connecting area, a holding area and a fastening area having at least one opening, such that the at least one mating latching element is formed on the connecting area, the connecting area is connected via a swivel axis to the holding area, and the holding area is arranged perpendicular to the fastening area.

21. The patchboard according to claim 11, wherein the terminal element has a connecting area and a conductor guide area, such that the at least one mating latching element is formed on the connecting area, and the conductor guide area projects over a front surface of the honeycomb component.

22. The patchboard according to claim 21, wherein the conductor guide area has multiple clamping sections for clamping individual conductors.

23. The patchboard according to claim 11, wherein the multiple honeycomb components are arranged in two directions of the patchboard that are different from one another and are connected to one another, and in each honeycomb component, at least one terminal element is arranged on two sides of the patchboard.
